(19) United States
(12) Patent Application Publication
(10) Pub. No.: US 2012/0033241 A1
(43) Pub. Date: Feb. 9, 2012

(54) IMAGE FORMING APPARATUS AND METHOD OF PRODUCING E-BOOK THEREOF

(75) Inventors: Sun-young PARK, Suwon-si (KR); Hyun-sub Kil, Suwon-si (KR); Jong-heon Ji, Suwon-si (KR)

(73) Assignee: Samsung Electronics Co., Ltd., Suwon-si (KR)

(21) Appl. No.: 13/192,781

(22) Filed: Jul. 28, 2011

(30) Foreign Application Priority Data
Aug. 9, 2010 (KR) 2010-76644

(51) Int. Cl. G06K 15/02

(52) U.S. Cl. 358/1.13

(57) ABSTRACT

A method of producing an electronic book (e-book) including displaying a selection screen including pre-stored document data, when a selection of a plurality of document data is received through the selection screen, displaying at least one menu applicable to the selected document data, when a selection of a menu to produce an e-book from among the menus is received, producing the e-book and displaying an edit screen to edit the produced e-book, and, when the produced e-book is edited with the edit screen, producing the e-book including the plurality of document data according to the editing.

### CROSS-REFERENCE TO RELATED APPLICATIONS

This application claims the benefit under 35 U.S.C. §119(a) from Korean Patent Application No. 10-2010-0076644, filed Aug. 9, 2010, in the Korean Intellectual Property Office, the disclosure of which is incorporated herein by reference in its entirety.

### BACKGROUND

1. Field of the Invention

The present general inventive concept generally relates to an image forming apparatus and a method of producing an electronic book (e-book) thereof, and more particularly, to an image forming apparatus which produces an e-book using a plurality of document data stored therein and a method of producing an e-book thereof.

2. Description of the Related Art

An image forming apparatus refers to an apparatus that prints printing data generated by a terminal apparatus such as a computer on a recording medium. Examples of such an image forming apparatus are copiers, printers, facsimile machines, or multifunction peripherals (MFP) complexly realizing the functions of the aforementioned devices in a single device.

Recently, as personal mobile devices have been developed and diverse information is easily available to users, an electronic book (e-book) is proliferating as a personal device.

With the proliferation of the e-book, the e-book content market is proliferating. However, the production of the contents used in the e-book is limited to primary publishing companies and the e-books provided by the publishing companies are also limited. In some situations, the user pays more money to enjoy the e-book.

### SUMMARY

Therefore, there is a need for a method of producing an e-book easily using contents owned by a user. The present general inventive concept provides an image forming apparatus which is capable of producing an e-book using a plurality of document data stored therein and a method of producing an e-book thereof.

Additional embodiments of the present general inventive concept will be set forth in part in the description which follows and, in part, will be obvious from the description, or may be learned by practice of the general inventive concept.

Exemplary embodiments of the present general inventive concept may provide a method of producing an electronic book (e-book) of an image forming apparatus, the method including displaying a selection screen on a display of the image forming apparatus including pre-stored document data, when a selection of a plurality of document data is received through the selection screen, displaying at least one menu applicable to the selected document data, when a selection of a menu to produce an e-book from among the at least one displayed menu is received, producing the e-book and displaying an edit screen on the display to edit the produced e-book, and when the produced e-book is edited with the edit screen, producing the e-book including the plurality of document data according to the editing.

The edit screen may be a user interface (UI) window through which an order of each of the plurality of selected document data is set, and the producing the e-book may include producing the e-book including the plurality of selected document data based on the set order.

The edit screen may be a UI window through which a page applicable to each of the plurality of selected document data is set, and the producing the e-book may include producing the e-book with the page which has been set for each of the document data.

The edit screen may be a UI window that receives a selection of a template applicable to the plurality of selected document data, and the producing the e-book may include producing the e-book using the selected template.

The producing the e-book may include producing the e-book by applying a different template to each of the plurality of selected document data.

The producing the e-book may include producing a book cover corresponding to the e-book and adding the produced book cover to the plurality of document data to produce the e-book.

The book cover may include information of at least one of a title of the e-book and an index value of the plurality of selected document data.

The producing the e-book may include producing the e-book by adding a slip sheet between the plurality of selected document data.

The slip sheet may include at least one of a title, a creation time, a number of pages, and a writer of a document datum placed after the added slip sheet.

The method may further include storing the produced e-book in a storage apparatus of the image forming apparatus.

The method may further include transmitting the produced e-book to an external apparatus.

The external apparatus may include an e-book terminal apparatus, and the producing the e-book may include producing the e-book in a format supported by the e-book terminal apparatus.

Exemplary embodiments of the present general inventive concept may also provide a method of producing an e-book of an image forming apparatus, the method including receiving a command with the image forming apparatus to produce an e-book, displaying an edit screen on a display of the image forming apparatus to edit a plurality of document data, and when the plurality of document data is edited with input received by the edit screen, producing the e-book including the plurality of document data according to the editing.

Exemplary embodiments of the present general inventive concept may also provide an image forming apparatus, including a storage unit to store document data, a display to display a user interface when a selection of a plurality of document data from the document data stored in the storage unit is received, to edit the plurality of selected document data, and an e-book producer which, when an editing is performed on the edit screen, produces the e-book including the plurality of document data according to the editing.

The user interface displayed on the display may be a UI window to receive a selection to set an order for each of the plurality of selected document data, and the e-book producer may produce the e-book with the plurality of selected document data based on the set order.

The user interface displayed on the display may be a UI window that receives a selection to set a page applicable to each of the selected document data, and the e-book producer may produce the e-book with the page which has been set for each of the selected document data.

The user interface displayed on the display may be a UI window to receive a selection of a template applicable to the selected document data is selected, and the e-book producer may produce the e-book using the selected template.

The e-book producer may produce the e-book by applying a different template to each of the selected document data.

The e-book producer may produce a book cover corresponding to the e-book and add the produced book cover to the plurality of selected document data to produce the e-book.

The book cover may include information of at least one of a title of the e-book and an index value of the plurality of selected document data.

The e-book producer may produce the e-book by adding a slip sheet between the plurality of selected document data.

The slip sheet may include at least one of a title, a creation time, a number of pages, and a writer of a document datum placed after the added slip sheet.

The image forming apparatus may include a communication interface connected to an external apparatus, a print processor to perform a printing job, and a controller to perform at least one of an operation to control the communication interface to transmit the produced e-book to the external apparatus, an operation to control the print processor to print the produced e-book, and an operation to control the storage unit to store the produced e-book.

The external apparatus may be an e-book terminal apparatus, and the e-book producer may produce the e-book in a format supported by the e-book terminal apparatus.

Exemplary embodiments of the present general inventive concept may also provide a method of producing an electronic book (e-book) with an image forming apparatus, the method including receiving a selection from a user interface apparatus of the image forming apparatus of one or more documents, receiving a selection of one or more templates to arrange and format the selected one or more documents, and generating an e-book from the arranged and formatted one or more documents.

The method may include displaying a preview image of the generated e-book on the user interface.

The method may include transmitting the generated e-book to an e-book terminal apparatus communicatively coupled to the image forming apparatus.

The method may include generating print data from the generated e-book, and printing the generated print data onto an image forming medium with the image forming apparatus.

The method may include receiving a selection from the user interface apparatus to select an order of the selected one or more documents, and generating the e-book according to the selected order of the one or more selected documents.

The generating the e-book of the method may include inserting a slip sheet between the selected documents.

The method may include where the slip sheet includes at least one of a title, a creation time, a number of pages, and a writer name.

### BRIEF DESCRIPTION OF THE DRAWINGS

These and/or other embodiments of the present general inventive concept will become apparent and more readily appreciated from the following description of the embodiments, taken in conjunction with the accompanying drawings of which:

FIG. 1 is a block diagram illustrating an image forming apparatus according to exemplary embodiments of the present general inventive concept;

FIGS. 2 to 8 are views illustrates examples of user interface (UI) windows according to exemplary embodiments of the present general inventive concept;

FIG. 9 is a view illustrating an example of a book cover added to an e-book according to exemplary embodiments of the present general inventive concept;

FIG. 10 is a view illustrating an example of a slip sheet added to an e-book according to exemplary embodiments of the present general inventive concept; and

FIG. 11 is a flowchart illustrating a method of producing an e-book according to exemplary embodiments of the present general inventive concept.

### DETAILED DESCRIPTION OF THE EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

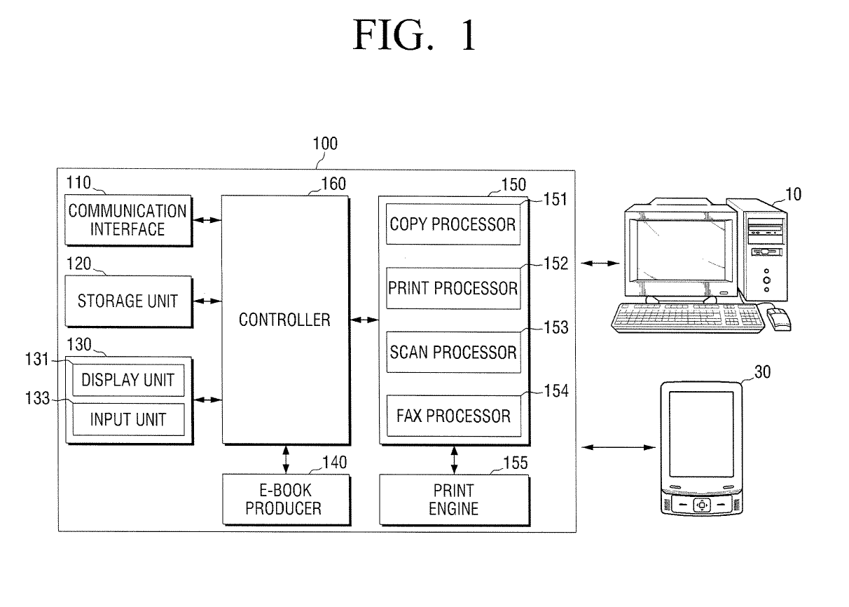

FIG. 1 is a block diagram illustrating an image forming apparatus 100 according to exemplary embodiments of the present general inventive concept.

Referring to FIG. 1, the image forming apparatus 100 includes a communication interface 110, a storage unit 120, a user interface 130, an e-book producer 140, a function unit 150, a print engine 155, and a controller 160.

The communication interface 110 can communicatively connect via wired communication the image forming apparatus 100 to a printing control terminal apparatus 10 or an e-book terminal apparatus 30, and can be connected to the printing control terminal apparatus 10 or the e-book terminal apparatus 30 via a local area network (LAN), the Internet, a universal serial but (USB) port, and/or any other suitable wired and/or wireless communication network or interface to carry out the exemplary embodiments of the present general inventive concept as disclosed herein. The communication interface 110 may receive document data (and/or job data) from the printing control terminal apparatus 10 or may receive fax data from an external fax server (not illustrated).

The communication interface 110 may transmit job data, such as scan data or fax data, which may be generated by the function unit 150, which will be described later, to the printing control terminal apparatus 10 or the fax server (not illustrated).

The communication interface 110 may transmit a produced e-book to an external apparatus. More specifically, the communication interface 110 may transmit the e-book which is produced by the e-book producer 140 to the printing control terminal apparatus 10 and/or the e-book terminal apparatus 30. The communication interface 110 may automatically transmit the e-book which has been produced and stored in the storage unit 120 to the e-book terminal apparatus 30, when the e-book terminal apparatus 30 is communicatively connected to the image forming apparatus 100.

The communication interface 110 may receive information regarding the e-book terminal apparatus 30 from the e-book terminal apparatus 30. The information of the e-book terminal apparatus 30 may include one or more e-book formats supported by the e-book terminal apparatus 30 and a storage capacity (e.g., the amount of available memory and/or storage space in a solid state memory device, hard disk drive, and/or solid state drive). The information of the e-book terminal apparatus 30 may be transmitted to the e-book producer 140 to determine a format of the e-book.

The e-book recited herein refers to a content that is usable in the e-book terminal apparatus 30 and may be a content that may be a dedicated e-book format such as PDF (Portable Document Format), EPUB (Electronic Publication), DJVU but also a format such as TXT (a general text format), PPT (a Microsoft® PowerPoint® format), DOC (a Microsoft® Word® format), and XPS (XML (Extensible Markup Language) Paper Specification).

The storage unit 120 may store document data. More specifically, the storage unit 120 may store document data which may be used when the function unit 150 performs a function, such as input data and/or output data of the function unit 150. For example, the storage unit 120 may store printing data (PCL (printer command language), PostScript (PS), a page description language (PDL)), scan data, copy data, fax transmit data, and fax receive data.

The storage unit 120 may classify the document data (e.g., classified document data may be sorted into several folders, with each folder having a different data classification) according to characteristics of the document data or a received selection (e.g., a received selection from a user). For example, the storage unit 120 may store general document data in a ‘Document Box’, may store security document data to be protected in a ‘Secure Box’ with a password, and may store public document data to be open to the public (e.g., data that has general access without restrictions) in a commonly used ‘Public Box’.

If the image forming apparatus 100 can perform a direct printing operation, the storage unit 120 may store a file such as JPG (Joint Photographic Experts Group) or DOC and use it as printing data. The ‘direct printing’ recited herein refers to an operation that can print by transmitting a file to an image forming apparatus without executing an application at a terminal apparatus such as a PC, a lap top computer, a personal digital assistance (PDA), and a digital camera.

The storage unit 120 may store the produced e-book. Specifically, the storage unit 120 may store the e-book which is produced by the e-book producer 140. The storage unit 120 may store the information of the e-book terminal apparatus 30 received from the e-book terminal apparatus 30. The storage unit 120 may be an internal storage medium or an external storage medium of the image forming apparatus 100, such as a removable disk including a USB memory or a web server over a network. The storage unit 120 may be one or more solid state memory devices, hard disk drives, and/or solid state drives.

The user interface 130 may have a plurality of function keys through which various functions and/or operations supported by the image forming apparatus 100 can be set and/or selected by the user. The user interface 130 can display information provided by the image forming apparatus 100. The user interface 130 may include a display unit 131 such as a monitor and an input unit 133 such as a mouse, keyboard, and/or keypad. The user interface 130 may be a device to receive input and output information to a display simultaneously, such as a touch pad and/or touch screen.

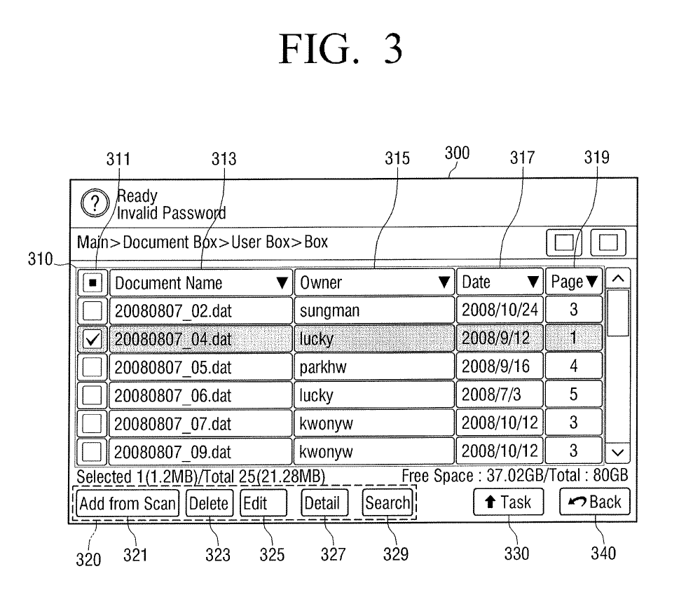

The user interface 130 can display a selection screen that may include pre-stored and/or received document data. Specifically, the user interface 130 may display the selection screen to display a plurality of documents pre-stored in the storage unit 130. The selection screen recited herein may be a user interface (UI) window that displays a plurality of documents (e.g., where the documents may be in a list) and will be explained below with reference to FIG. 3. Using the selection screen, the user can select document data for producing the e-book. That is, the selection screen of the user interface 130 may receive selections of document data, where the selected document data may be used to produce the e-book.

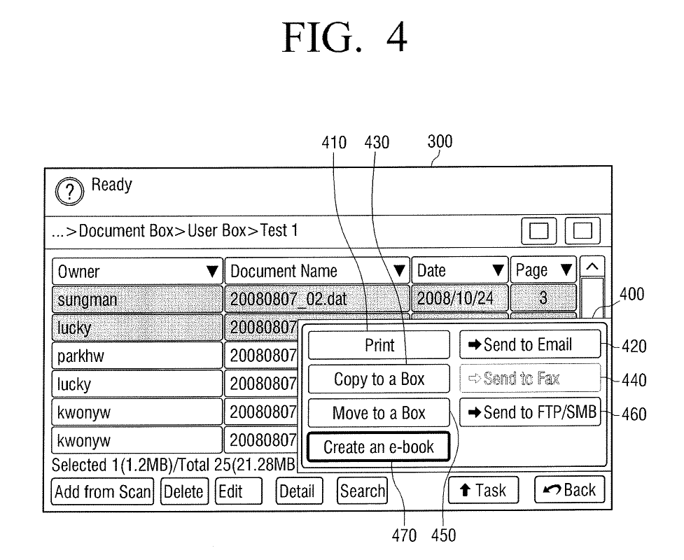

If a plurality of document data are selected on the selection screen (i.e., a plurality of selections of document data are received as input with the selection screen), the user interface 130 can display one or more menus applicable to the selected document data. That is, the user interface 130 may display one or more menus according to the received selections of document data. More specifically, the user interface 130 may display menus including one or more processing items regarding the plurality of selected document data. The menus are UI (user interface) windows which display one or more functions, operations, and/or selections of the image forming apparatus 100 applicable to the selected document data and will be explained in detail with reference to FIG. 4.

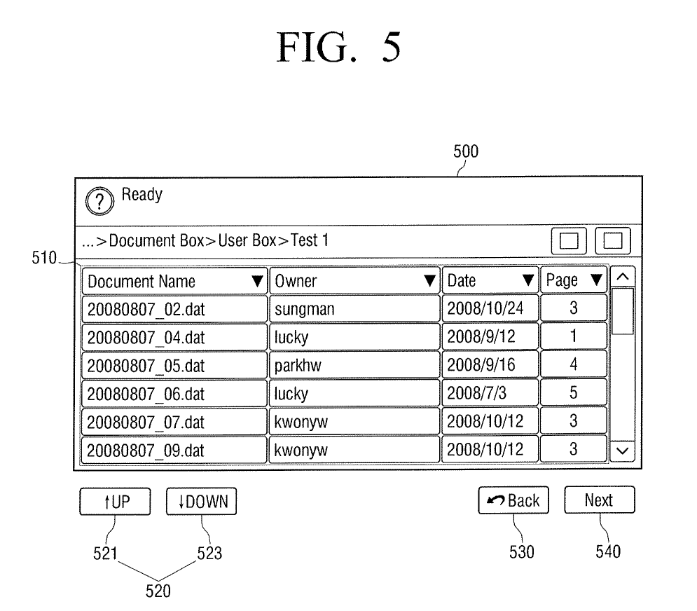

When a menu to produce the e-book is selected from among the menus displayed by the user interface 130, an application to produce the e-book can be executed (e.g., by the image forming apparatus 100) such that the user interface 130 displays an edit screen for the selected document data. The edit screen is a UI window which may receive one or more edit selections to edit the selected document data, and may include a UI window to set an order. A UI window may receive input to set a page to be applied to each of the selected document data, and a UI window may receive a template selection to be applied to the selected document data. The edit screen will be explained in detail with reference to FIGS. 5 to 8.

The template recited herein may be a layout image that is generated by the user or has been previously generated at the image forming apparatus 100 to be combined with image data received by the image forming apparatus 100.

The application can be a program executable by the image forming apparatus 100 to produce an e-book and may be installed in the image forming apparatus 100 by a manufacturer or by a firmware update (e.g., an update of the application that may be stored in storage unit 120 and/or controller 160).

The user interface 130 may provide a preview image of the e-book, where the preview image is displayed on the display unit 131. More specifically, the user interface 130 may display (e.g., on the display unit 131) a form of the e-book which is to be produced by the e-book producer 140. Accordingly, the user can view the form of the e-book to be displayed on the e-book terminal apparatus 30 in advance. If there is an issue to be addressed with the preview image of the e-book, an edit setting may be modified so as to adjust the preview image. For example, the user may edit a form of an index of the e-book or information to be added to the index using the UI window, and also may edit information to be added to the slip sheet of the e-book.

The e-book producer 140 can produce the e-book with the plurality of document data according to an input edit condition. That is, the e-book producer 140 may produce the e-book according to the received document data and one or more received edit inputs. Specifically, if an order of the plurality of document data is set, the e-book producer 140 can change the order of the plurality of document data according to the set order, and can produce the e-book with the changed order. If pages are set regarding the document data having a plurality of pages, the e-book producer 140 produces the e-book with only the set pages.

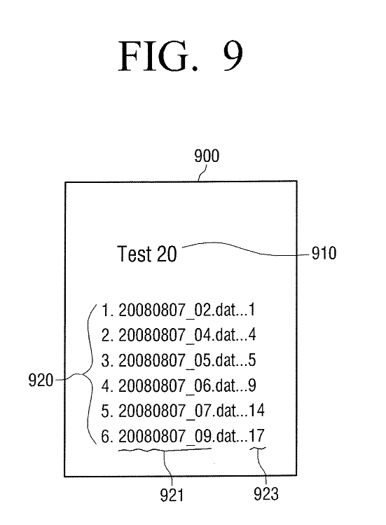

The e-book producer 140 can produce a book cover (i.e., an e-book cover image) corresponding to the e-book and can add the produced book cover to the plurality of document data to produce the e-book. Specifically, the e-book producer 140 can produce the book cover including information of the e-book such as a title and an index of the e-book, which is received as input through the user interface 130, and can add the produced book cover to the plurality of selected document data, thereby producing the e-book. The information added to the book cover may be automatically added by the information pre-stored in the storage unit 120 or may be received as input or modified through the UI window. The form of the book cover produced according to exemplary embodiments of the present general inventive concept will be explained in detail with reference to FIG. 9.

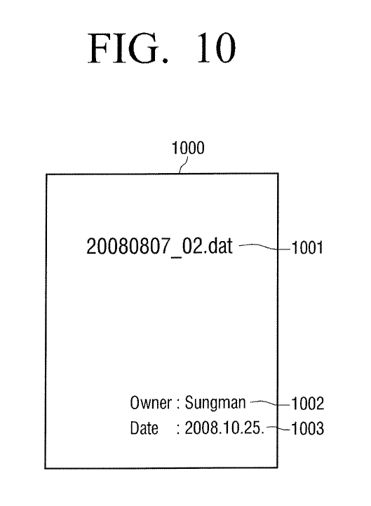

The e-book producer 140 may add the slip sheet between the plurality of selected document data when producing the e-book. The slip sheet may be a page that is added to discriminate the plurality of document data. The slip sheet may be a blank page or a page including information regarding a title of document data placed after the slip sheet, a creation time of document data, the number of pages of document data, and a writer of document data. The information included in the slip sheet may also be automatically added by the information pre-stored in the storage unit 120, or may be input or modified by the user through the UI window. An example of the slip sheet produced according to exemplary embodiments of the present general inventive concept will be explained later with reference to FIG. 10.

The e-book producer 140 can produce the e-book using a selected template. More specifically, the e-book producer 140 may change the layout of the document data using the template selected through the user interface 130 in producing the e-book. If a plurality of templates are selected, the e-book producer 140 can apply different templates of the plurality of selected templates to the plurality of document data in producing the e-book. That is, one or more of the selected plurality of templates may be applied to one or more sections of the e-book, and one or more other templates of the plurality of templates may be applied to different sections of the e-book. If one template is selected, the e-book producer 140 applies the one template to all of the plurality of document data in producing the e-book.

The e-book producer 140 may produce the e-book in a format that is supported by the e-book terminal apparatus 30 to which the produced e-book is to be transmitted. Specifically, the e-book producer 140 may produce the e-book in the format that is usable by the corresponding e-book terminal apparatus 30, using the information of the e-book terminal apparatus 30 pre-stored in the storage unit 120.

The function unit 150 can perform the one or more functions and/or operations supported by the image forming apparatus 100 such as copying, printing, scanning, fax transmitting, and fax receiving. Specifically, the function unit 150 may include a copy processor 151, a print processor 152, a scanning processor 153, and a fax processor 154. The a copy processor 151, a print processor 152, a scanning processor 153, and a fax processor 154 may be microprocessors, application specific integrated circuits, field programmable gate arrays, programmable logic devices, integrated circuits, controllers, and/or any suitable processor to carry out the exemplary embodiments of the present general inventive concept as disclosed herein.

The copy processor 151 can perform a copying function and can perform an operation to output data scanned by a scan unit of the image forming apparatus 100 through the print engine 155 to form an image onto an image forming medium. The scanned data may be stored in the storage unit 120 as copy data.

The print processor 152 can perform a printing function and can perform an operation of outputting printing data received through the communication interface 110 through the print engine 155 to form an image onto an image forming medium. Specifically, the print processor 152 may store a page description language (PDL) such as PCL or PS received through the communication interface 110 in the storage unit 120 as printing data, and also may store data rendered in a binary format in the storage unit 120 as printing data.

The scanning processor 153 can perform a scanning function and processes data scanned by the scan unit in the image forming apparatus 100. The scanned data may be stored in the storage unit 120 in a predetermined data format (e.g., a RAW data format) before an image is processed, or image-processed data may be stored in the storage unit 120 after having been converted into an XPS format such as JPG, TIFF, and PDF. Also, the scanned data may be converted into a data format such as ASCII (American Standard Code for Information Interchange) or Unicode data format by performing text recognition using an OCR (optical character recognition).

The fax processor 154 can perform a fax transmitting or fax receiving function and can perform an operation of outputting fax data received from a fax unit through the print engine 155 or an operation of transmitting data scanned by the scan unit to the fax unit.

The print engine 155 may be an apparatus to receive a print operation from the copy processor 151 and/or the print processor 152 to print an image and/or text onto an image forming medium. The print engine 155 may include one or more colors of toner to form the image on the image forming medium, which may be paper.

The controller 160 can control the image forming apparatus 100. That is, the controller 160 can control the communication interface 110, the storage unit 120, the user interface 130, the e-book producer 140, and the function unit 150. More specifically, upon receiving a command to produce the e-book from the user, the controller 160 can display the user interface 130 to display the plurality of document data stored in the storage unit 120. When a plurality of document data and an edit setting are selected through the user interface 130, the controller 160 can control the e-book producer 140 to apply the selected edit setting and produce the e-book with the plurality of document data.

If the e-book has been produced through the above-described process, the controller 160 may store the produced e-book in the storage unit 120. The controller 160 may transmit the e-book to the printing control terminal apparatus 10 and/or the e-book terminal apparatus 30. The controller 160 may print the e-book onto an image forming medium using the print processor 152 and the print engine 155.

As described above, the image forming apparatus 100 can produce the e-book using the plurality of document data stored therein (e.g., in storage unit 120) so that the user can obtain the e-book easily. The user can edit the e-book, including adding a book cover or a slip sheet through the UI window, so as to increase a user's convenience.

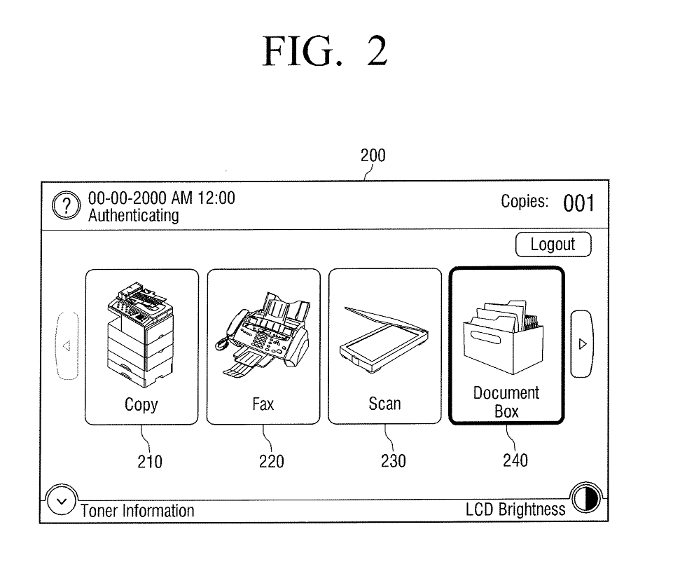

FIGS. 2 to 8 are views illustrating examples of UI windows according to exemplary embodiments of the present general inventive concept.

Specifically, FIG. 2 illustrates an example of a UI window 200 which can be displayed by display unit 131 of the user interface 130 to receive a selection of a function of the image forming apparatus 100. Referring to FIG. 2, the UI window 200 can include a ‘Copy’ area 210, a ‘Fax’ area 220, a ‘Scan’ area 230, and a ‘Document Box’ area 240. Selections of one or more of the ‘Copy’ area 210, a ‘Fax’ area 220, a ‘Scan’ area 230, and a ‘Document Box’ area 240 displayed in the UI window 200 may be received by the user interface 131.

The ‘Copy’ area 210 can receive a command to perform a copying function of the image forming apparatus 100, the ‘Fax’ area 220 can receive a command to perform a fax transmitting function of the image forming apparatus 100, and the ‘Scan’ area 230 can receive a command to perform a scanning function of the image forming apparatus 100.

The ‘Document Box’ area 240 can receive a command to identify document data stored in the storage unit 120 of the image forming apparatus 100. When the user selects the ‘Document Box’ area 240, a UI window 300 of FIG. 3 may be displayed. When a plurality of storing folders exist in the image forming apparatus 100 (e.g., where the storing folders are stored in the storage unit 120), other storing folders such as ‘Secure Box’ and ‘Public Box’ are displayed along with the ‘Document Box’.

FIG. 3 illustrates an example of the UI window 300 which is displayed on the display unit 131 of the user interface 130 to receive a selection of a plurality of document data. Specifically, the UI window 300 of FIG. 3 is an example of a UI window displayed when the ‘Document Box’ area 240 of FIG. 2 is selected.

Referring to FIG. 3, the UI window 300 (or the ‘selection screen’ described above) includes a ‘document data display’ area 310, a ‘processing way input’ area 320, a ‘Task’ area 330, and a ‘Back’ area 340. As illustrated in FIG. 3, the ‘document data display’ area 310 can include a document selection box 311, a document name area 313, a document owner area 315, a date area 317, and a page area 319.

The ‘document data display’ area 310 displays the plurality of document data stored in the storage unit 120 of the image forming apparatus 100. The user may select one or more document data to be processed from the displayed document data. That is, a user may select one or more of the documents listed in document name area 313 by selecting a document selection box 311 that corresponds to the document listed in document name area 313. A checkmark or other indicator may appear in the document selection box 311 of a selected document. Each of the documents listed in the document name area 313 may have a corresponding owner listed in document owner area 315. Each of the documents listed in the document name area 313 may have a creation date, modification date, and/or access date listed in date area 317. Each of the documents listed in document area 313 may have a corresponding number of pages that are displayed in pare area 319.

The ‘processing way input’ area 320 may include an area 321 to receive a scan command to add document data, an area 323 to receive a command to remove the selected document data from the list, an area 325 to receive a command to edit the selected document data, an area 327 to receive a command to display additional information regarding the selected document, and an area 329 to receive a command to retrieve document data stored in the image forming apparatus 100.

The ‘Task’ area 330 can receive a command to display the functions of the image forming apparatus 100 applicable to the selected document data. If the user selects the ‘Task’ area 330, a UI window 400 illustrated in FIG. 4 is displayed.

The ‘Back’ area 340 is to receive a command to display the previous UI window 200 of the current UI window 300. If the user selects the ‘Back’ area 340, the UI window 200 illustrated in FIG. 2 is displayed.

The user can select a plurality of document data to be used to produce the e-book from among the stored document data using the UI window 300. That is, the user may select one or more of the documents listed in the document area 313 by selecting a corresponding document selection box 311.

FIG. 4 is a view illustrating an example of the UI window 400 to display one or more menus applicable to the selected document data. More specifically, when the user selects the ‘Task’ area 330 in FIG. 3, the UI window 400 can be displayed on the UI window 300 of the display unit 131 in a pop-up form.

Referring to FIG. 4, the UI window 400 (or the menus described above) can display one or more functions and/or operations applicable to the selected document data. Specifically, the UI window 400 can include a ‘Print’ area 410, a ‘Send to Email’ area 420, a ‘Copy to a Box’ area 430, a ‘Send to Fax’ area 440, a ‘Move to Box’ area 450, a ‘Send to FTP/SMB’ area 460, and a ‘Create an e-book’ area 470.

The ‘Print’ area 410 can receive a command to print the selected document data, and the ‘Send to Email’ area 420 can receive a command to send an email for the selected document data.

The ‘Copy to a Box’ area 430 can receive a command to copy the selected document data to another storage folder (e.g., a storage folder of storage unit 120), and the ‘Send to Fax’ area 440 can receive a command to send a fax including the selected document data.

The ‘Move to a Box’ area 450 can receive a command to move the selected document data to another storage folder, and the ‘Send to FTP/SMB’ area 460 can receive a command to send the selected document data to an FTP (File Transfer Protocol) or an SMB (Server Message Block).

The ‘Create an e-book’ area 470 can receive a command to produce the e-book with the selected document data. When the user selects the ‘Create an e-book’ 470, a UI window 500 can be displayed by the display unit 131 as illustrated in FIG. 5.

Using the UI window 400, the user can perform one or more processes with respect to the selected document data, and can start producing the e-book by selecting the ‘Create an e-book’ area 470 among the displayed menus.

FIGS. 5 to 8 are views illustrating examples of UI windows which display the edit screen for the plurality of document data selected by the user according to exemplary embodiments of the present general inventive concept. More specifically, FIG. 5 illustrates an example of the edit screen that is displayed when the ‘Create an e-book’ area 470 is selected by the user in FIG. 4.

Referring to FIG. 5, a UI window 500 (or the edit screen) includes a ‘selected document data display’ area 510, an ‘order setting’ area 520, a ‘Back’ area 530, and a ‘Next’ area 540.

The ‘selected document data display’ area 510 displays the plurality of document data selected by the user in order to produce the e-book. Specifically, the ‘selected document data display’ area 510 displays the plurality of document data selected by the user with the document selection box 311 through the UI window 300.

The ‘order setting’ area 520 can receive a command to edit an order of pages of the plurality of document data, and includes an ‘up’ menu 521 to arrange the selected document data in an ascending order and a ‘down’ menu 523 to arrange the selected document data in a descending order.

The ‘Back’ area 530 can receive a command to display the previous UI window 400 of the current UI window 500. If the user selects the ‘Back’ area 530, the UI window 400 may be displayed as illustrated in FIG. 4.

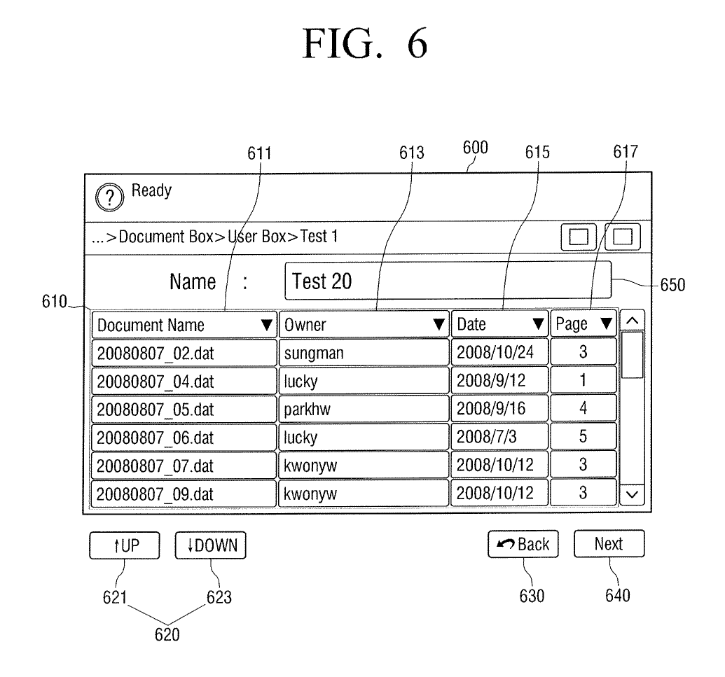

The ‘Next’ area 540 can receive a command to progress to a next setting when the order setting of the plurality of document data is completed. When the user selects the ‘Next’ area 540, a UI window 600 can be displayed by the display unit 131 as illustrated in FIG. 6.

Using the edit screen 500, the user can edit the order of the plurality of selected document data.

FIG. 6 illustrates an example of the UI window 600 which is displayed when the ‘Next’ area 540 of FIG. 5 is selected.

Referring to FIG. 6, the UI window 600 can include a ‘selected document data display’ area 610, an ‘order setting’ area 620, a ‘Back’ area 630, a ‘Next’ area 640, and a ‘Name’ area 650.

The ‘selected document data display’ area 610 displays the plurality of document data selected by the user in order to produce the e-book. The user may change a name, a writer, and a creation time of a corresponding document datum by selecting a ‘Document Name’ area 611, an ‘Owner’ area 613, and a ‘Date’ area 615 of the displayed document data, and may set the number of pages for a corresponding document datum by selecting a ‘page’ area 617.

The ‘order setting’ area 620 can receive a command to edit an order of pages for the plurality of document data. The ‘order setting’ area 620 can include an ‘up’ menu 621 to arrange the selected document data in an ascending order and a ‘down’ menu 623 to arrange the selected document data in a descending order.

The ‘Back’ area 630 can receive a user command to display the previous UI window 500 of the current UI window 600. When the user selects the ‘Back’ area 630, the UI window 500 can be displayed as illustrated in FIG. 5.

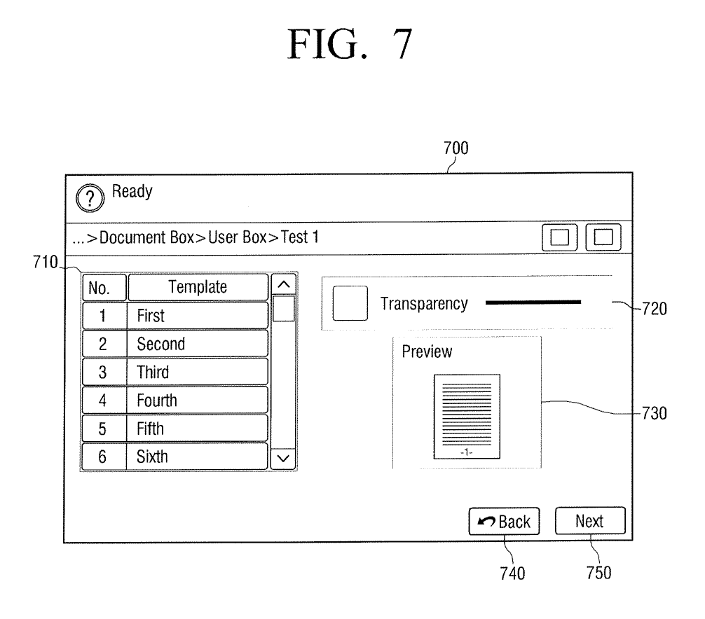

When the order setting for the plurality of document data and the name setting of the e-book are completed, the ‘Next’ area 640 can receive a user command to progress a next setting. If the user selects the ‘Next’ area 640, a UI window 700 is displayed as illustrated in FIG. 7.

The ‘Name’ area 650 can receive the name of the e-book to be included to the book cover of the e-book from the user.

Using the edit screen 600, the user can edit the title of the e-book which is to be added to the book cover.

FIG. 7 is a view illustrating an example of the UI window 700 which is displayed when the Next' area 640 of FIG. 6 is selected according to exemplary embodiments of the present general inventive concept.

Referring to FIG. 7, the UI window 700 can include an ‘applicable template display’ area 710, a ‘selected template explaining’ area 720, a ‘preview’ area 730, a ‘Back’ area 740, and a Next' area 750.

The ‘applicable template display’ area 710 can display a plurality of templates stored in the storage unit 120 and can receive a selection of one of the templates from UI window 700 displayed by the user interface 130.

The ‘selected template explaining’ area 720 can display information regarding the template selected by the user. That is, the ‘selected template explaining’ area 720 describes how the template may edit, change, alter, and/or format the document to which the selected template is applied.

The ‘preview’ area 730 can display a preview image of document data to which the template selected by the user is applied.

The ‘Back’ area 740 can receive a user command to display the previous UI window 600 of the current UI window 700. If the user selects the ‘Back’ area 740, the UI window 600 is displayed as illustrated in FIG. 6.

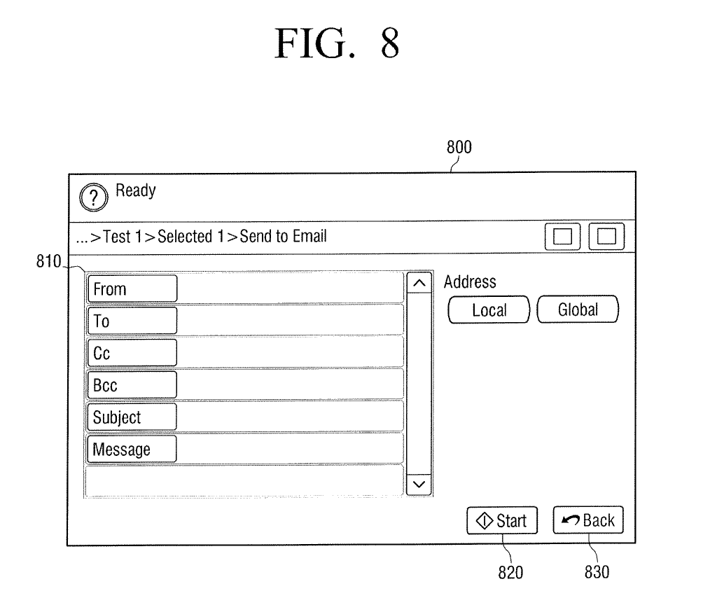

When the setting of the template is completed, the ‘Next’ area 750 receives a user command to progress a next setting. When the user selects the ‘Next’ area 750, a UI window 800 illustrated in FIG. 8 is displayed.

Using the edit screen 700, the user can edit the layout of the document data to be added to the e-book. The user may set a different template for each of the plurality of document data. The user may also set the same template for one or more selections of document data, and different templates for one or more selections of the document data. Editing using the edit screen 700 may be performed as much as the number of document data selected by the user.

FIG. 8 is a view illustrating an example of a UI window to set a sending method of the e-book according to exemplary embodiments of the present general inventive concept. Specifically, the user may select one or more methods of sending the e-book. When the user selects an email to send the e-book or when a pre-set sending option is an e-mail, a UI window 800 can be displayed to receive email address information of a receiver, as illustrated in FIG. 8.

FIG. 8 illustrates the UI window 800 can receive diverse information (e.g., information for the “From,” “To,” “Cc,” “Bcc,” Subject” and “Message” of the email) to send the e-book via email. The information may be received and/or entered into email fields 810, that may include, for example, “From,” “To,” “Cc,” “Bcc,” Subject” and “Message” as illustrated in FIG. 8. However, the email information may be pre-set. A UI window for receiving address information of an FTP server may be displayed by the user interface 130. Selection of the start button 820 may transmit the e-book via email to the recipient identified in the email fields 810. Selection of the back button 830 may display the UI window 700 illustrated in FIG. 7 and described above.

FIG. 9 is a view illustrating an example of a book cover 900 to be added to the e-book according to exemplary embodiments of the present general inventive concept.

Referring to FIG. 9, the book cover 900 can include an ‘e-book title display’ area 910 and an ‘e-book index display’ area 920.

The ‘e-book title display’ area 910 can display the title of the e-book input from the user.

The ‘e-book index display’ area 920 can display names 921 of the document data included in the e-book and starting pages 923 of the document data. The ‘e-book index display’ area 920 may be generated automatically based on the information stored in the storage unit 120 of the image forming apparatus 100, and the index may be modified according to user's purpose and/or according to one or more selections received from a user via the user interface 130. Although only the starting page is illustrated in the index of FIG. 9 in the exemplary embodiments of the present general inventive concept, a page range of each data, that is, a starting page and an ending page of the data may be displayed. A total number of pages, and a number of pages for each section of data may also be displayed.

FIG. 10 is a view illustrating an example of a slip sheet 1000 to be added to the e-book according to exemplary embodiments of the present general inventive concept.

Referring to FIG. 10, the slip sheet 1000 can include information such as a title 1001, a writer 1002, and a creation time 1003 of the document data placed, for example, after the added slip sheet 1000 or may be included on the slip sheet 1000 as illustrated in FIG. 10. The information added to the slip sheet 1000 may be automatically generated based on the information stored in the storage unit 120 of the image forming apparatus, without requiring the user to input separately, may be modified according to user's purpose, or may be modified according to one or more selections received from a user via the user interface 130. In the above, the slip sheet including the information has been described, but a slip sheet without extra information may be provided.

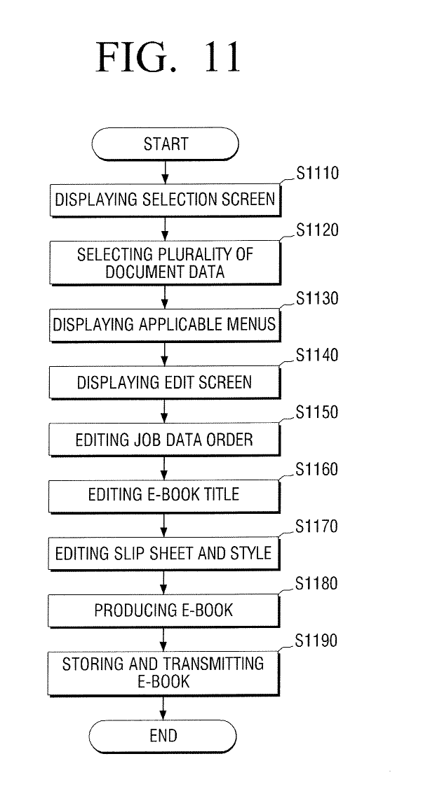

FIG. 11 is a flowchart illustrating a method of producing an e-book according to exemplary embodiments of the present general inventive concept.

Referring to FIG. 11, the selection screen of the pre-stored document can be displayed at operation S1110. Specifically, the selection screen can be displayed to receive a selection of a plurality of document data to be used in producing the e-book. Using the selection screen, the user can select the plurality of document data at operation S1120.

The menus applicable to the selected document data can be displayed at operation S1130. More specifically, the menus including the functions of the image forming apparatus 100 applicable to the selected document data can be displayed. When the user selects a menu to produce the e-book from the menus, the edit screen for the selected document data can be displayed at operation S1140.

The user can set an order of the selected document data at operation S1150. Specifically, the selected document data can be displayed and an order of each document data can be edited.

Information of the e-book to be produced can be set at operation S1160. Specifically, if a book cover is to be added to the e-book, information of a title and an index of the e-book, which can be included in the book cover, may be set.

A slip sheet and a style of the e-book can be set at operation S1170. Specifically, when a slip sheet is to be added to the e-book, information to be included in the slip sheet can be set and a template applicable to the selected document data can be selected.

One template may be selected to be applied to all of the selected document data or a different template may be selected for each of the document data. Alternatively, one template may be applied to selected document data, and different templates may be applied to other selected document data.

The e-book can be produced with the plurality of document data based on the input edit setting at operation S1180. More specifically, the operation of producing the e-book has been described in relation to the e-book producer 140 and thus a detailed explanation is omitted.

The produced e-book can be transmitted from the image forming apparatus 100 at operation S1190. More specifically, the produced e-book may be transmitted to the e-book terminal apparatus 30 and/or the printing control terminal apparatus 10. The e-book may be displayed in advance (e.g., in ‘preview’ area 730 illustrated in FIG. 7) prior to being transmitted to the outside. When there is an issue to be addressed with the format and/or content of the displayed e-book, the e-book may be modified. The produced e-book may be stored in the image forming apparatus 100.

According to the above-described method of producing the e-book, the e-book can be produced using the document data stored in the image forming apparatus 100 and thus the user can produce the e-book with ease. Also, it is possible to edit the plurality of document data in various ways in producing the e-book, so as to increase a user's convenience. The method of producing the e-book illustrated in FIG. 11 may be executed on the image forming apparatus having the configuration of FIG. 1 or may be executed on other type of image forming apparatus.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can be transmitted through carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although various example embodiments of the present general inventive concept have been illustrated and described, it will be appreciated by those skilled in the art that changes may be made in these example embodiments without departing from the principles and spirit of the general inventive concept, the scope of which is defined in the appended claims and their equivalents.

What is claimed is:

1. A method of producing an electronic book (e-book) of an image forming apparatus, the method comprising:
displaying a selection screen on a display of the image forming apparatus including pre-stored document data;
when a selection of a plurality of document data is received through the selection screen, displaying at least one menu applicable to the selected document data;
when a selection of a menu to produce an e-book from among the at least one displayed menu is received, producing the e-book and displaying an edit screen on the display to edit the produced e-book; and
when the produced e-book is edited with the edit screen, producing the e-book including the plurality of document data according to the editing.

2. The method as claimed in claim 1, wherein the edit screen is a user interface (UI) window through which an order of each of the plurality of selected document data is set,
wherein the producing the e-book comprises producing the e-book including the plurality of selected document data based on the set order.

3. The method as claimed in claim 1, wherein the edit screen is a UI window through which a page applicable to each of the plurality of selected document data is set,
wherein the producing the e-book comprises producing the e-book with the page which has been set for each of the document data.

4. The method as claimed in claim 1, wherein the edit screen is a UI window that receives a selection of a template applicable to the plurality of selected document data,
wherein the producing the e-book comprises producing the e-book using the selected template.

5. The method as claimed in claim 4, wherein the producing the e-book comprises:
producing the e-book by applying a different template to each of the plurality of selected document data.

6. The method as claimed in claim 1, wherein the producing the e-book comprises:
producing a book cover corresponding to the e-book; and
adding the produced book cover to the plurality of document data to produce the e-book.

7. The method as claimed in claim 6, wherein the book cover includes information of at least one of a title of the e-book and an index value of the plurality of selected document data.

8. The method as claimed in claim 1, wherein the producing the e-book comprises:
producing the e-book by adding a slip sheet between the plurality of selected document data.

9. The method as claimed in claim 8, wherein the slip sheet includes at least one of a title, a creation time, a number of pages, and a writer of a document datum placed after the added slip sheet.

10. The method as claimed in claim 1, further comprising:
storing the produced e-book in a storage apparatus of the image forming apparatus.

11. The method as claimed in claim 1, further comprising:
transmitting the produced e-book to an external apparatus.

12. The method as claimed in claim 11, wherein the external apparatus includes an e-book terminal apparatus,
wherein the producing the e-book comprises producing the e-book in a format supported by the e-book terminal apparatus.

13. An image forming apparatus, comprising:
a storage unit to store document data;
a display to display a user interface when a selection of a plurality of document data from the document data stored in the storage unit is received to edit the plurality of selected document data; and
an e-book producer which, when an editing is performed on the edit screen, produces the e-book including the plurality of document data according to the editing.

14. The image forming apparatus as claimed in claim 13, wherein the user interface displayed on the display is a UI window to receive a selection to set an order for each of the plurality of selected document data,
wherein the e-book producer produces the e-book with the plurality of selected document data based on the set order.

15. The image forming apparatus as claimed in claim 13, wherein the user interface displayed on the display is a UI window that receives a selection to set a page applicable to each of the selected document data,
wherein the e-book producer produces the e-book with the page which has been set for each of the selected document data.

16. The image forming apparatus as claimed in claim 13, wherein the user interface displayed on the display is a UI window to receive a selection of a template applicable to the selected document data is selected,
wherein the e-book producer produces the e-book using the selected template.

17. The image forming apparatus as claimed in claim 16, wherein the e-book producer produces the e-book by applying a different template to each of the selected document data.

18. The image forming apparatus as claimed in claim 13, wherein the e-book producer produces a book cover corresponding to the e-book and adds the produced book cover to the plurality of selected document data to produce the e-book.

19. The image forming apparatus as claimed in claim 18, wherein the book cover includes information of at least one of a title of the e-book and an index value of the plurality of selected document data.

20. The image forming apparatus as claimed in claim 13, wherein the e-book producer produces the e-book by adding a slip sheet between the plurality of selected document data.

21. The image forming apparatus as claimed in claim 20, wherein the slip sheet includes at least one of a title, a creation time, a number of pages, and a writer of a document datum placed after the added slip sheet.

22. The image forming apparatus as claimed in claim 13, further comprising:
a communication interface connected to an external apparatus;
a print processor to perform a printing job; and
a controller to perform at least one of an operation to control the communication interface to transmit the produced e-book to the external apparatus, an operation to control the print processor to print the produced e-book, and an operation to control the storage unit to store the produced e-book.

23. The image forming apparatus as claimed in claim 22, wherein the external apparatus is an e-book terminal apparatus,
wherein the e-book producer produces the e-book in a format supported by the e-book terminal apparatus.

24. A method of producing an electronic book (e-book) with an image forming apparatus, the method comprising:
receiving a selection from a user interface apparatus of the image forming apparatus of one or more documents;
receiving a selection of one or more templates to arrange and format the selected one or more documents; and
generating an e-book from the arranged and formatted one or more documents.

25. The method of claim 24, further comprising:
displaying a preview image of the generated e-book on the user interface.

26. The method of claim 24, further comprising:
transmitting the generated e-book to an e-book terminal apparatus communicatively coupled to the image forming apparatus.

27. The method of claim 24, further comprising:
generating print data from the generated e-book; and
printing the generated print data onto an image forming medium with the image forming apparatus.

28. The method of claim 24, further comprising:
receiving a selection from the user interface apparatus to select an order of the selected one or more documents; and
generating the e-book according to the selected order of the one or more selected documents.

29. The method of claim 24, wherein the generating the e-book comprises:
inserting a slip sheet between the selected documents.

30. The method claim 29, wherein the slip sheet includes at least one of a title, a creation time, a number of pages, and a writer name.
